(19) United States
(12) Patent Application Publication
(10) Pub. No.: US 2010/0142409 A1
(43) Pub. Date: Jun. 10, 2010

(54) Self-Forming Network Management Topologies

(76) Inventors: Liam Fallon, Athlone (IE); Daryl Parker, Roscommon (IE); Francoise Sailhan, Athlone (IE)

Correspondence Address: POTOMAC PATENT GROUP PLLC, P. O. BOX 270, FREDERICKSBURG, VA, 22404, US

(21) Appl. No.: 12/520,153

(22) PCT Filed: Dec. 21, 2006
(86) PCT No.: PCT/EP2006/070125

§ 371 Date: Feb. 25, 2010

(51) Int. Cl. H04L 12/28

(52) U.S. Cl. 370/255

(57) ABSTRACT

The present invention relates to a network management system, a network element and a method for managing the network management system, the system operating in a computer or telecommunication network. The network comprises at least one network element that is able to communicate in the network through links. A network management software is contained and run on the network element. According to the present invention the network management software comprises controlling means for each management function or functions that the network element is part of, the controlling means being able to form, reform and/or terminate the topology for the management function. It further comprises register means for each management function or functions that the network element is part of, the register means being able to register and share information about the topology for the management function.

### TECHNICAL FIELD

The present invention relates to a network management system, a network element and a method for managing the network management system, the system operating in a computer or telecommunication network. The network comprises at least one network element (1) that is able to communicate in the network through links. A network management software is contained and run on the network element (1).

### BACKGROUND

Network management is a software based business tool which relates to the management of computer and telecommunication networks of different sizes. Network management could refer to functions covering the complete network (multiple systems), regardless of the technology or vendor of the managed network elements. It could also refer to sub-network management, covering functions for different parts of the complete system. The network element can be any piece of equipment, such as a telecom or data node, for instance in the shape of base stations, radio controllers, routers or switches.

A network management system provides a package of end-user functions for the operation of the network. The functions refer to operation and maintenance of the network at a higher level. Examples of such functions are:
1. Hardware management—continuously keep inventory of all hardware present.
2. Software management—installation, upgrade, configuration activities etc.
3. Configuration management—enables the operator to set, modify and examine configuration parameters and files.
4. Performance management—provides data on the network performance with respect to accessibility, retainability etc.
5. Fault management—handling, subscription and logging of alarms and event.

Network management software may in some cases be installed in any node in the network and provides a GUI (graphical user interface) for operation. The management system supports the day-to-day operation and maintenance procedures.

The network management traffic is normally separated from user/signalling traffic, but is carried on the same physical links. The traffic can be thought of as logical or virtual links. Interfaces are used for providing the management communication with the network. Physical interfaces could for instance be Ethernet or IP over ATM. Protocols are also needed for the communication, such as FTP, HTTP or SSL. Application interfaces are also used.

A network management topology is a pattern of links connecting network elements, the management systems that manage those network elements (1), and the connections between the network element 1 and the management systems. Well known management systems today use a layered management topology forming a hierarchy. FIG. 1 show a typical topology used in current systems. The topology mappings for the management functions X and Y are marker TMM X and Y respectively. In the bottom of the topology each network element is managed by an element manager. In a higher layer the element manager is managed by a network manager. The element manager acts on the individual network elements and present an abstract view on the network management level. It forms a logical topology mapping for its function by reading data from the network elements connected to that element manager. The network manager may, as mentioned earlier, comprise a sub-network manager that manages element managers and is managed by a network manager.

The management function in each network manager forms a logical topology mapping for its function by reading data and manage the element managers (and sub-network managers) connected to the network manager. The management functions form and reform these logical topology mappings by reading and monitoring the data in the entity at the level below them and by reading data from other topologies on the same level. Network managers are connected to service and business management systems. Business management systems provide “back-office” IT support for customer service. Such customers could be in the fields of finance, retail, travel industry, sales etc. Services could be sales, order handling and invoicing. Service management is one step away from day-to-day direct customer interaction. Focus is on service delivery to customer as opposed to the network management. It could for instance comprise specific customer design and configuration of customer's equipment.

Another well known concept in the communication area is overlay networks. It is essentially a peer to peer network, with all the management modules in the network being equal and is formed on top of another network. The overlay network does not have a hierarchical layered structure; the element management and some of the network management runs in the network itself on the network elements. Nodes in the overlay can be thought of as being connected by virtual or logical links, each of which corresponds to a path, perhaps through many physical links, in the underlying network. FIG. 2 shows a typical management overlay network

In a management overlay network, a management module runs on each network element that is part of the management overlay network. That management module can communicate over virtual management links with management modules on other network elements in the management overlay network. A management module is a SW container for management software. Software for managing the network can run in management modules and communicate with software in other management modules using services provided by the management overlay network. A management overlay network provides the following services to management software running in a management module:
1. The ability to find out which other management modules are adjacent to the management module in which the software is running
2. The ability to communicate with software in other management modules.
3. The ability to add and remove network elements to and from the network in an ad-hoc (automatic) manner.

There are a number of problems with a hierarchic topology structure for network management systems. There is only one single network management hierarchic topology in the network, which is static and represents the connectivity for the management system of the network. This topology is not optimal for every management function. Furthermore, the management function has to reform the topology mapping by reading and monitoring data in their subordinate entities. This means that the difficulties in monitoring networks and its services increase with the complexity of the networks, which influences the ability of topology mapping. The effect is that the development of management systems focuses more on the ability to monitor the network than how to manage than to provide better features for management. Moreover, the management systems at higher level assume that management functions are actually deployed in a hierarchical manner and expect that the connections in the hierarchy are made in a controlled manner. This means that the process of adding and removing entities to the management structure is assumed to be rather static.

The management function in each manager will have problems to form and reform a topology map for its management function itself; based on the information it knows about and the information it can read from its subordinate nodes. It is very difficult to form advanced management functions that work across managers; each manager is aware of its topological information and that of its subordinate nodes. Managers cannot share topological information.

The system will for a number of reasons also have problems to manage a management overlay (peer to peer network), with all the management modules in the network being equal and is formed on top of another network. A management overlay does not have a hierarchical topology structure, which the network management system assumes. Management functions can also be developed in a peer to peer manner, with data being exchanged on east-west interfaces between the management modules in the overlay, making it difficult for a network management system to track the data. Network elements and therefore management modules can finally appear and disappear automatically in the normal operation of a network, behavior that a conventional network management system does not expect.

### SUMMARY

The object of the present invention is to provide a system and method for network management which can manage different management function topologies and reform topology mapping by monitoring the data in their subordinate entities.

The object is achieved by means of a network management and a network element operating in a computer or telecommunication network. The network comprises at least one network element that is able to communicate in the network through links. A network management software is contained and run on the network element. The network management software comprises controlling means for each management function or functions that the network element is part of, the controlling means being able to form, reform and/or terminate the topology for the management function. It further comprises register means for each management function or functions that the network element is part of, the register means being able to register and share information about the topology for the management function.

In a preferred embodiment at least one network element is formed into a topological group for a management function. One element in the group has the role of group leader for this group, wherein the group leader coordinates and displays the topology of its group. The network elements can be part of more than one topological group, depending on the management function. Moreover, a topological group for each function could be part of a hierarchic topology of layered groups and forming an entire network for the management function. Moreover, a network element (1) in one topology level can be group leader for a group of network elements on the level next below, wherein the group leader of the highest topological group represents the entire network.

In a preferred embodiment the topology groups are formed, reformed and terminated based on parameters. The parameters are set statically before system start-up, dynamically while the system is running, for instance by direct operator intervention or using policies, or deduced at run time by reading state information from the network and calculating their value. The reforming relates to the structure of the topology or the hierarchy, the size of the group or promotion/demotion of group leader.

In a preferred embodiment the register means of a specific network element appears at more than one position in a topology for a specific management function. The register means can also use a table to hold topological data with an entry for each position in the management function topology that the register means appears in. The register means can furthermore be identical and parameters influences the way in which it registers and shares information about the topology for the management function and the way in which is interacts with other register means.

In another preferred embodiment the controlling means comprises role controllers such as leader role controllers or member role controllers, the controllers being contained and run in the management module for each management function or functions that the network element is part of. The role controllers are able to form, reform and/or terminate the topology of the management function by controlling the permission to perform certain operations that are assigned to certain roles in a management function topology. More than one role controller could be run in each storage means.

In a preferred embodiment a management module in run on the network element, the module comprising the network management software. In another preferred embodiment the network element consists in a telecom or data node, for instance in the shape of a base station, radio controller, router or switch. The element can also communicate within the network with software protocols.

In another preferred embodiment a network element is arranged in the computer or telecommunication network according to the preferred embodiment above, in which a management module is running and comprising the management software.

The object is also achieved by means of a method for managing a network management system operating in a computer or telecommunication network. The network comprises at least one network element that is able to communicate in the network through links, wherein network management software is contained and run on the network element. A first step performed is forming, reforming and/or terminating the topology for each management function or functions that the network element is part of, said step being performed by controlling means included in the network management software. The second step being performed is register and sharing information about the topology for each management function or functions that the network element is part of, said steps being performed by register means included in the network management software.

According to a preferred embodiment the register means for a particular management function topology communicates and co-operates with other register means to form and reform the entire topology for the network. In another embodiment the register means can furthermore track the topological data for the network element itself and the topological connections the network element has with register means in other network elements.

In a further embodiment a topological event such as reformation of management function topology is issued by the network management software and sent to an external management system.

The main advantage with the present invention is that multiple management topologies for a network or networks can exist. The management topologies are automatically set up and developed in the network itself. Their structure and hierarchy is formed and reformed automatically by the network elements. The management topologies are dynamic, self forming and automatically adjusted as conditions in the network changes.

The management entities on network elements can exchange management information in a peer to peer manner. The network elements themselves can use the topology to provide better management functions in the network. A network element can address other elements in its topology group and is so aware of its environment. A group leader can co-ordinate the management of a group, can aggregate data for a group and can act as a mediation point for its group. Management applications can thereby be formed and run in a much more distributed manner and consequently some management functions can now be run in a distributed manner in the management overlay of the network itself.

Network management systems no longer have to be aware of and directly configure management topologies. The topologies are constructed and reformed in the network itself and the management applications passively read and monitor the topologies in the network. It can delegate the configuration of management topology to the network elements and can read the structure of the topologies and map the changes by monitoring events. Parameters or policies can also be used to control network management topologies tailored to the specific management functions.

Moreover, the system allows external systems to find and communicate with network management topologies, to navigate through and read data from network management topologies, to change parameters used to control network management topologies, to reset and reform network management topologies and to monitor changes in network management topologies. In many cases, element managers and even network managers may even be redundant. External systems connect directly to the management function in the network.

### BRIEF DESCRIPTION OF DRAWINGS

FIG. 1 are a prior art network management topology

FIG. 2 are a management overlay network

FIG. 3 are topological groups for management functions X and Y

FIG. 4 are topological leaders for topological groups for management functions X and Y

FIG. 5 are a topological group hierarchy for a management function X

FIG. 6 are topology entities for two management functions in a management overlay

FIGS. 7a and 7b are topology entity tables for a topology

FIG. 8 are leader role controllers and member role controllers co-operating at topology levels

FIG. 9 are a member role controller start sequence

FIG. 10 are a topology entity handling of a group query message

FIG. 11 are an add group member sequence

FIG. 12 are a group member removal sequence

FIG. 13 are a group leader shutdown sequence

FIG. 14 are an external registration of topologies

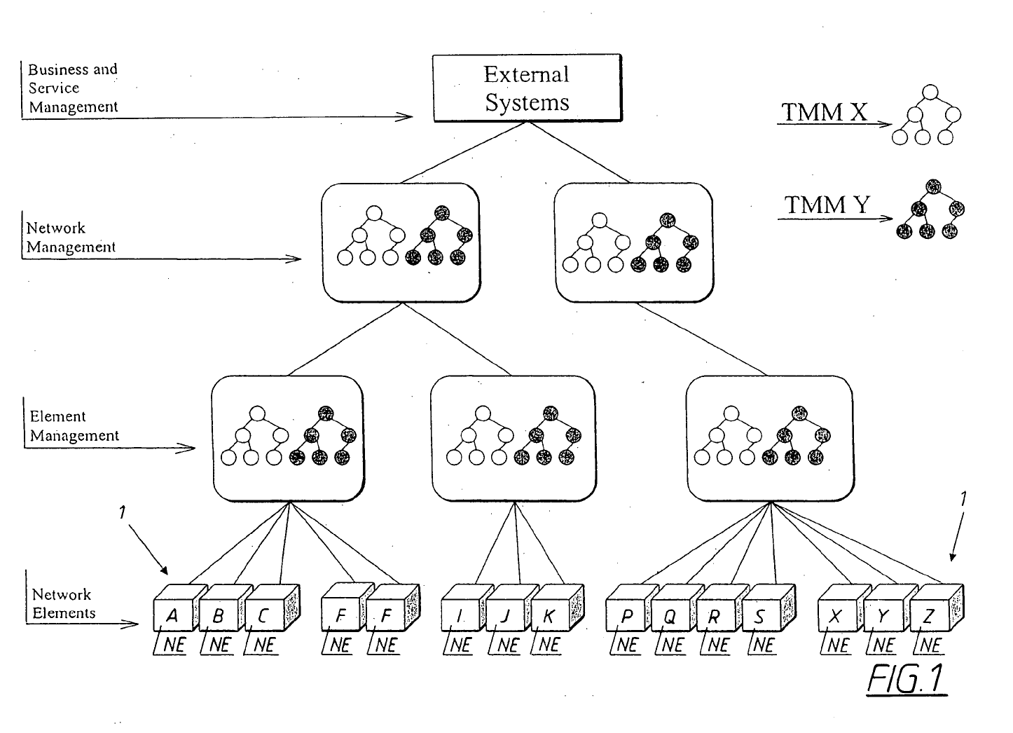

### DETAILED DESCRIPTION

The system and method for carrying out the inventive network management will now be described with reference to an embodiment. The embodiment contains a number of features each contributing to the present invention. The embodiment described herein discloses a system and method in which cooperating network elements form (bootstrap) topological groups of network elements for the purposes of network management.

Topology Group for Network Management

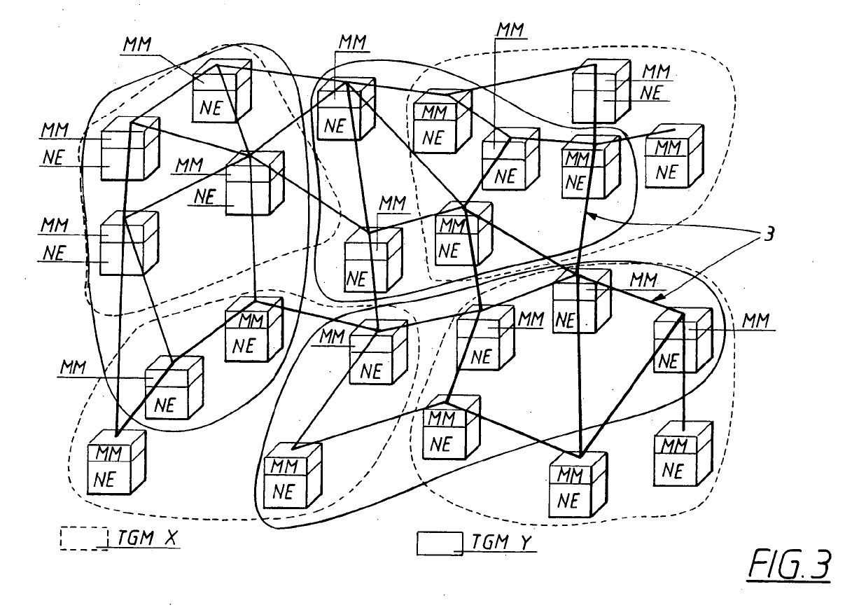

FIG. 3 shows an example of a network with its network elements formed into such topological groups for two hypothetical management functions; Topological Management Function X and Topological Management Function Y, named TGM X and TGM Y respectively. The management modules are named MM and forms an overlay on top of the Network Elements named NE. As shown by the overlapping areas of FIG. 3, a network element can be part of more than one group, depending on the management function. Thereby, it will be able to communicate 3 with many different network elements in dependency of the function present.

As mentioned in the background a network element could be any piece of equipment, such as a telecom or data node, for instance in the shape of base stations, radio controllers, routers or switches. The management module is a pure software container for software such as network management software. Such software containers already exist as mentioned in the background. However, these containers should now instead needs to hold the new, inventive management features. These features will be described later.

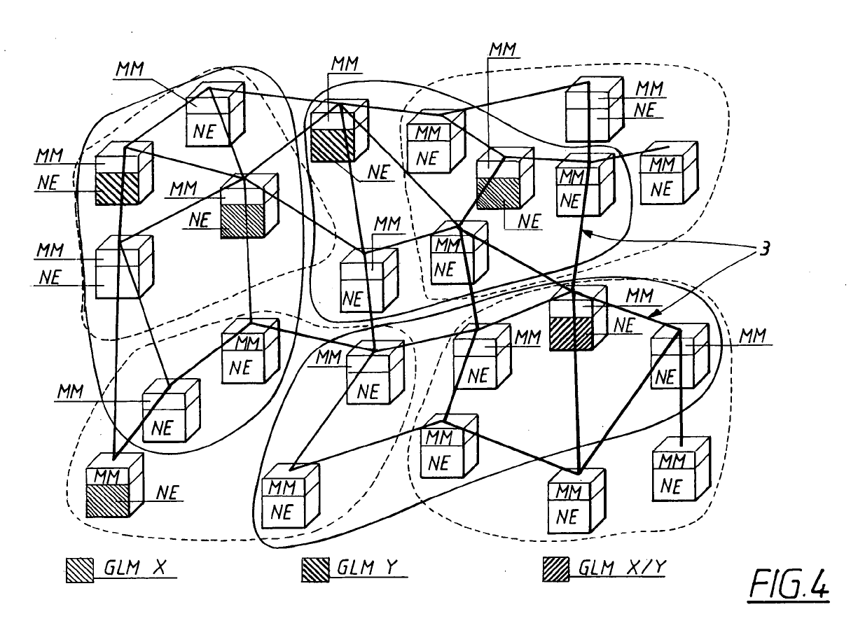

There is one topological group for each function. Each topological group has a group leader and may also have one or more group members. The group leader coordinates and displays the topology of its group. In FIG. 4 the group leader for function X (named GLM X), the group leader for function Y (named GLM Y) and the group leader for function X and Y (named GLM X/Y) are marked. The management function is as mentioned in the background hardware or software management, fault management, configuration management and performance management. The communication 3 between the modules (shown as lines drawn between the modules) is enabled by certain management application protocols such as FTP, HTTP or SSL via wire or radio links.

Hierarchical Topology for Network Management

The flat grouping for different functions, as shown in FIGS. 3 and 4, is a very useful approach for aggregating data or carrying out management functions in a specific small group of network elements. Each management module can contain the software needed to monitor each group member for topology mapping function and aggregate data for the operation of this management functions. However, there are many cases where data aggregation and management functions must work over more than one group.

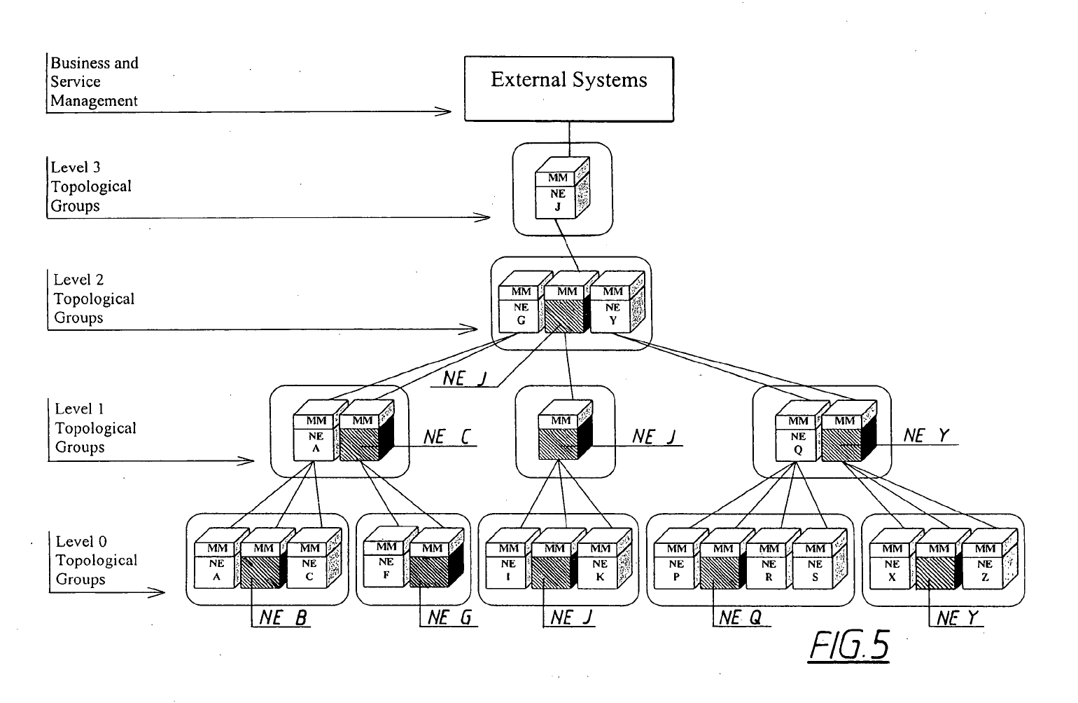

A hierarchic topology of groups is then provided to enable management tasks to work over different groups. An example of such a management function topology is shown in FIG. 5. The topological groups are layered in order to better divide the management of the network. A network element in a level 1 group is the group leader for a level 0 group, and therefore manages all the network elements in that particular level 0 group. This originates from that the network elements in this level 0 group, which elect a group leader that will also represent the level 0 topological group in the level 1 topological group. Consequently, the level 1 group (for instance NE A and G) elects who should be group leader and represents in level 2, and so forth for level 3.

A management system may map a number of topologies at the same time, where a particular management function may have its own topology. The management function may also share topologies or use one or more topologies simultaneously.

Network Element's Role in a Hierarchical Topology

For every management function, a network element could exist in a management topology at one level, but an important part of the invention is that it can exist in more than one level and in different groups at the same time. Consequently, it can in theory communicate with every network elements in a peer to peer manner. Individual network elements in a topology can communicate with other network elements in that topology in a peer to peer manner. A network element can address other network elements in its topology group.

A group leader can co-ordinate the management of that group, can aggregate data for a group and can act as a mediation point for its group. This means that management applications can be formed and run in a much more distributed manner than in a traditional management approach. As shown in FIG. 5, the group leader node in the highest topological group in the hierarchy (level 3) will represent the entire network for a particular management function to external systems. That group leader is responsible for publishing the topology of the network. The group leader registers its address with a well known registry. External users look up that registry to find the address of the group leader and communicate with that group leader when they wish to use the topology for a given management function.

An external system can also get topological information on any network element in the system when it has the address of that network element. An external system can read topological data or data associated with the management function for all network elements in the topology, for network elements in a sub-tree of the topology or for a single network element in the topology. An external system can navigate a topology from any point to any point in the topology by moving up and down through the levels of the topology using operations for querying parents and children of a network element.

Basis for Formation, Reformation and Termination of Topology Groups

The formation of topological groups, the election of group leaders, and controlling the topological group levels in a hierarchy is based on parameters. Those parameters can be set statically before system start-up. Parameters can also be set or altered dynamically while the system is running by direct operator intervention or using policies. Parameters can also be deduced at run time by reading state information from the network and calculating their value. The following non-exhaustive list gives examples of parameters that might influence the formation of topologies:
1. The type of network element
2. The networking technology the network element runs
3. The location of the network element
4. The services that the network element can provide
5. The other networks and network elements that the network element is aware of
6. The authority that allowed the network element to connect to the network
7. The availability schedule of the network element
8. The capabilities of the network element such as CPU power, available memory, or available disk storage
9. The costs associated with using the network element such as latency, load, bandwidth usage, and monetary cost
10. The number of network elements already in a topological group
11. The topological groups a network element is already part of

The parameters can be used to influence the structure of topologies and can be set by an external system. An external system can use this to order a reformation of an entire topology or parts thereof. The parameters can also be set using policies. The topologies will also automatically reform if network elements are added to the network, moved around the network or removed from the network. Topologies may also reform if any of the parameters that influence the topology are changed. Topologies may become bigger or smaller. New topology groups may appear, merge, split, or disappear within a topology. Promotion and demotion of topology leaders may occur. New levels may appear or levels may disappear in the hierarchy of a topology.

The topology of a management function is preferably tuned in a way that optimizes it for the management function in question. For instance a performance management function may use network elements having database support and large disks as group leaders so that those network elements can cache data for their group members.

Event Subscription for External Systems

An external system may register for topological events. Notification subscriptions may have the scope of an entire topology, a sub-tree of a topology, or a single network element. When an event occurs of a type that an external system has subscribed, the network element issues a message and sends it to the external system. The following non-exhaustive list illustrates the type of events to which an external system might subscribe:
1. Appearance or disappearance of a network element in a topological group at any level or a particular level in the topology
2. Promotion or demotion of a network element to or from group leader at any level in the topology
3. Promotion or demotion of a network element to or from being the top group leader and external interface point in a topology
4. Change in management function data on a network element in the topology.
5. Management function specific event occurs in the topology

Topology Entities for Self-Forming of Topologies

As described earlier the network elements can become members of more than one function topology and play an active role in the formation and reformation of topologies. This is enabled by an overlay of management modules which have the role of software container for new management software features that will provide the network elements with the tools for being an active part of the network management system.

To provide these self-formed topologies, one Topology Entity 4, from now on named TE, is contained and runs in the management module overlay of each network element for every management function topology that the network element is a part of. TE's 4 are register means that is contained and run in the management module 2 for each management function or functions that the network element 1 is part of. The register means is able to register and share data and control said registration and sharing. The sharing relates to communicating data between different register means. From here on TE's will be used to represent the register means.

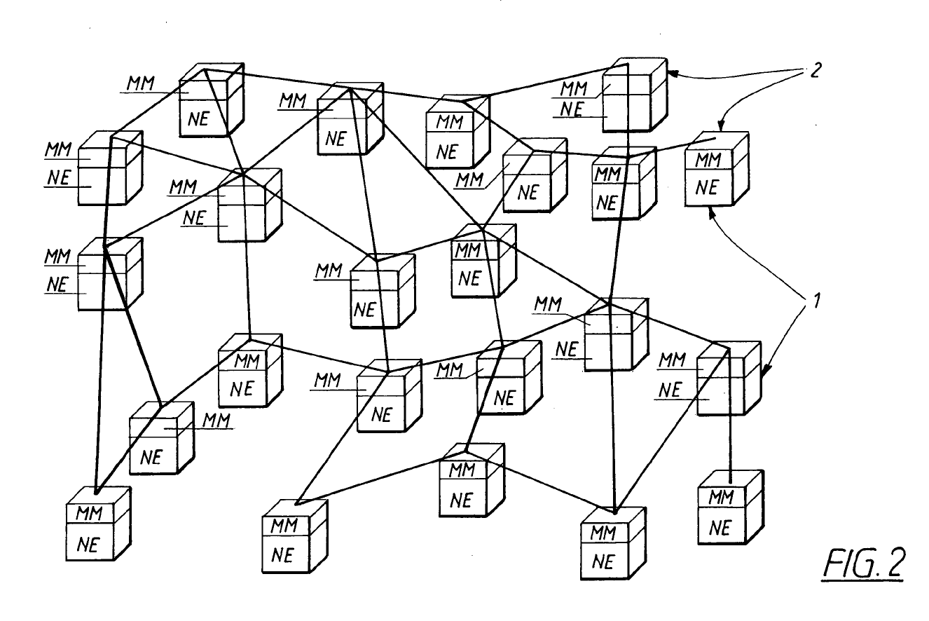

The TE's 4 role is to register and share information about the topology for the management function. The topology entities for a particular management function topology communicate and co-operate to form and reform the entire topology for the network as shown as shown in FIGS. 2-4. The TEs will have a number of tasks as described later in this patent application, and examples of software features which the management modules contain for these tasks are:
1. Lifecycle management. Allows Topology entities to be started, stopped, restarted, to log messages, isolate TEs from each other and to provide information on resources used by TEs.
2. Notification service. Allows TEs to send notifications to TEs in other management modules.
3. Directory service. Allows TEs to find out about TEs in other management modules.
4. Connectivity service. Allows TEs in different management modules to set up, reform and shut down peer to peer sessions.
5. Persistency service. Allows TEs to save data to persistent storage.
6. Code distribution. Provides mechanisms for updating, installing and removing TEs in management modules.

A Common Topology Entity Having Different Roles

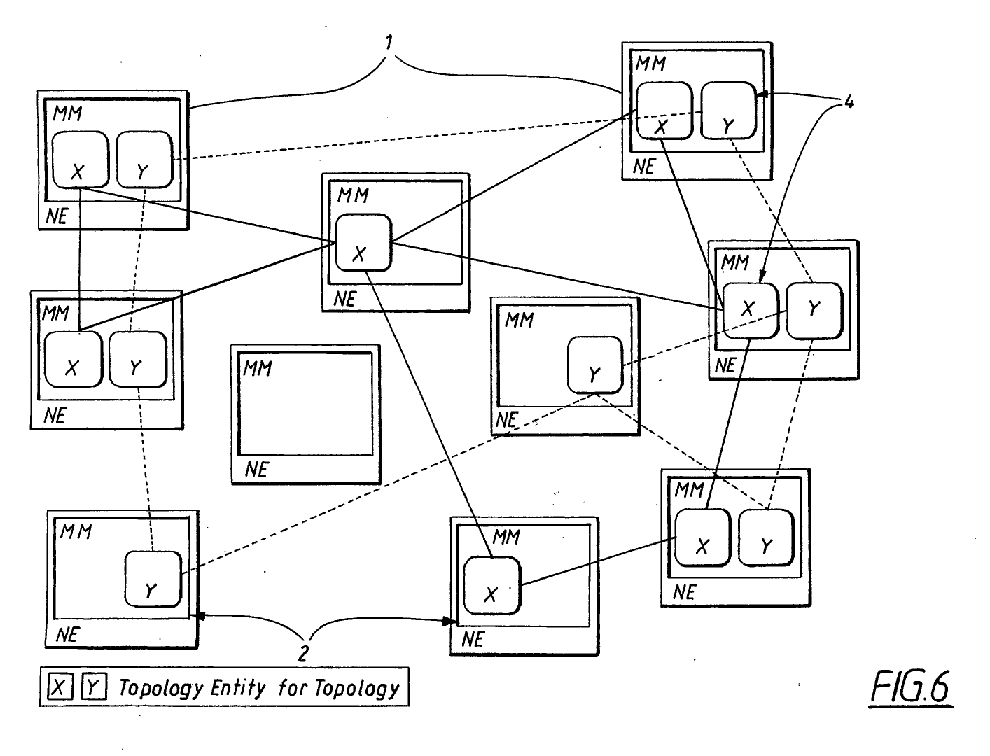

Each TE 4 in all management modules in the network for every management function is identical. Parameters as described earlier are used to influence the way in which the TE register its topology data and the way in which it interacts with other topology entities to form or reform a complete network topology as shown in FIGS. 5-6. A complete management function topology is made up of the sum of all the local topologies registered in all the topology entities included in that topology. When a topology is fully formed, it exists logically as a hierarchical layered structure, even though it is instantiated in a flat management overlay. A TE manages the topological structure of a topology for its local network element. It keeps track of the topological data for the network element itself and the topological connections the network element has with topology entities in other network elements.

Topology Entity's Role in a Hierarchical Topology

A TE 4 of a specific network element may appear at many levels in the hierarchical topology. Moreover, if a TE appears at a certain level in a topology, it must appear at every level below that level in the topology. The reason is that when a topology group of members is formed, see FIG. 2, they will appoint one of them to become a group leader, see FIG. 3, and represent the group on the next, higher level. From FIG. 5 it is also shown that logically, a TE must be a group member at the highest level that it exists in the hierarchy and a group leader at every level of the hierarchy below that level. The reason is that there are only group leaders on all the levels above the lowest. Even at the highest level the TE will become a group member, since an external system will act on top of this level.

Content of Topology Entity

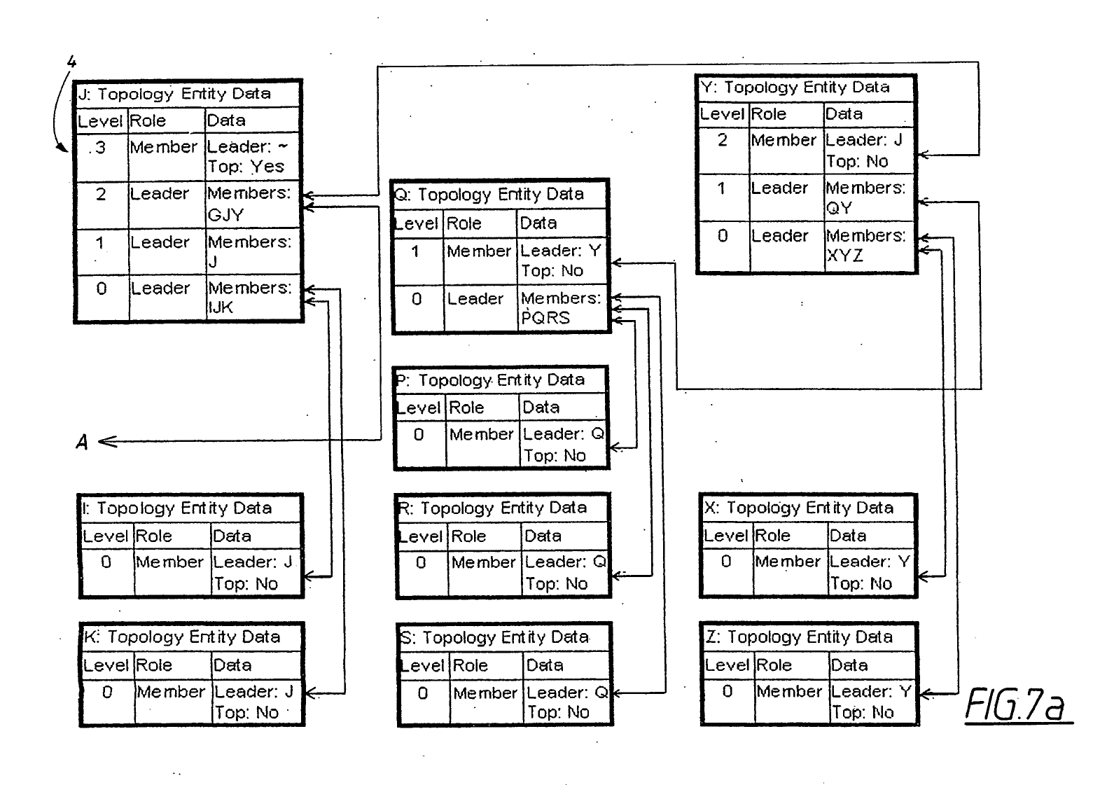

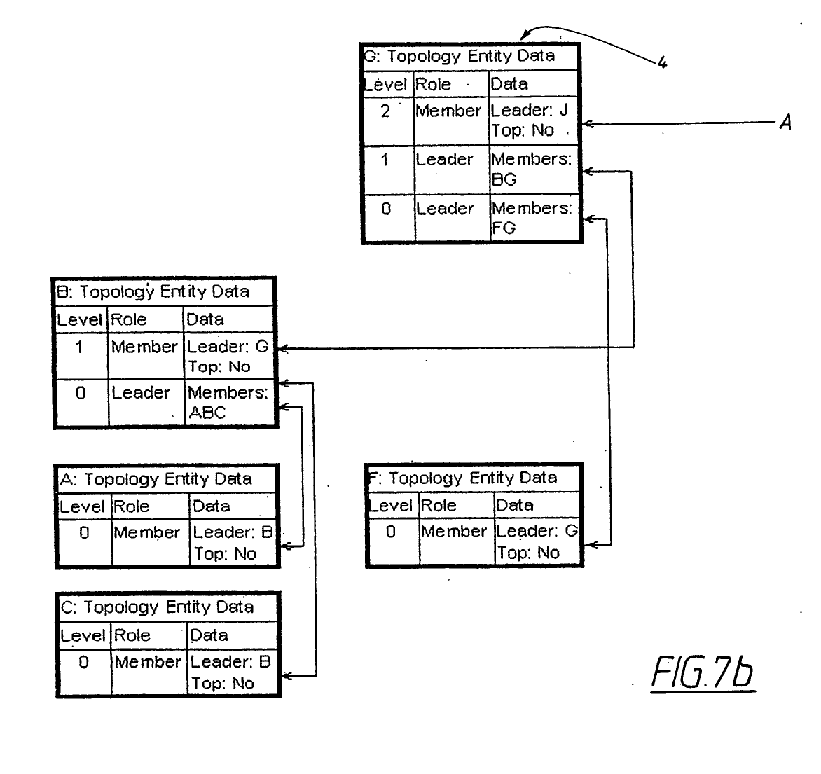

The TE 4, contained in the management module of each network element, uses a table to hold the topological data. This can be seen in FIGS. 7a and 7b. The table has an entry for each hierarchical level in the topology that the TE appears in. In one column the table records the role of the TE at a certain level. When a TE has the role of group member at a level, the TE records the address of the group leader for the group in the role or a flag indicating if that TE is the top level entity in the topology. If a TE is a group leader at a level, it records the addresses of each of the members of the group for which it is leader at that level.

Leader and Group Role Controllers for Reforming Topology Structures

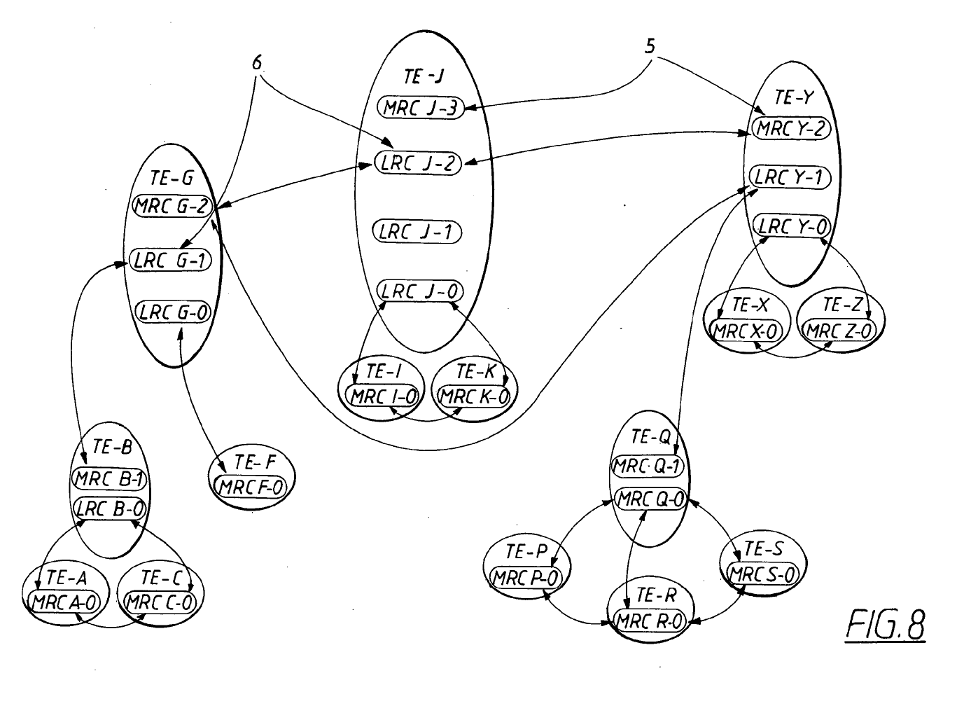

Topology entities communicate with each other in order to form and reform management function topology structures such as that shown in FIG. 8. A TE 4 uses role controllers to keep track of the topology for each level in which it partakes, see FIG. 8. Role controllers are controlling means that is contained and run in the management module 2 for each management function or functions that the network element 1 is part of. The controlling means are able to form, reform and/or terminate the topology for the management function as will be described later. From here on role controllers will be used to represent the controlling means.

The role controllers are an access control as part of the management software in the management module 2 in a computer system, which restricts system access to authorized users. The permissions to perform certain operations are assigned to specific roles. Within a network, roles are created for various management functions. The permissions to perform certain operations are assigned to specific roles. Using such controllers means that a TE 4 can have many Leader Role Controllers 6 (from now on named LRC), one for each level at which the TE is a group leader. A TE has a single Member Role Controller 5 (from now on named MRC) instance for the highest topology level where the TE partakes in the topology. The LRCs and MRCs at a particular level in the topology entities in the topology co-operate with each other to handle the topology at that level for the entire topology or for sub-trees of the topology.

The LRCs 6 and MRCs 5 supervise the topology at all levels of the topology. If a supervision timeout occurs on a LRC or MRC, the LRC or MRC resets and reforms its topology. In that way, the topology adjusts to network changes automatically.

Method for Forming and Reforming of a Topology

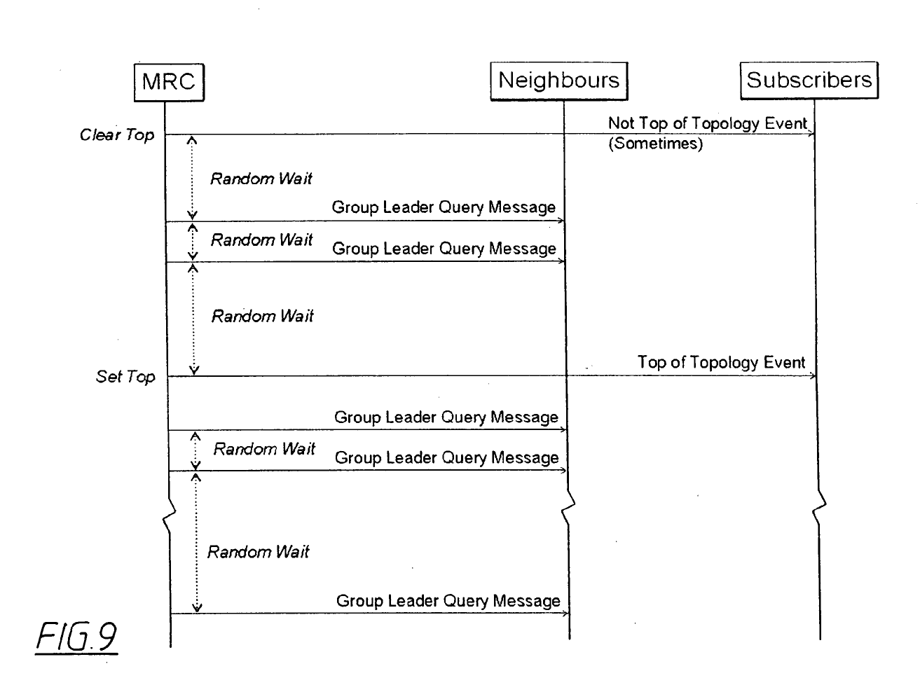

The methodology for automatic forming and reforming of network management function topologies is based on a number of sequences. It will now be described with reference to FIG. 9-13.

Initial Start

One sequence relates to initial start of a network element. When the TE 4 starts, clears and initializes its topology data table. It then places a single entry at level 0 in the table indicating that the TE is a member of a topology at that level and has no group leader.

MRC Start and Restart

Another sequence relates to the start of the MRC 5 at level 0, which sequence is shown in FIG. 9. When the MRC starts at a given level, it realises that it is a member of a group and has no group leader. If the MRC had assumed before that it was the group member at the top of a topology and had set the “top” flag, that flag will be cleared. The MRC issues a not top of topology event to any external entities that have subscribed for that event. The MRC waits for a parameterized random length of time. Then the MRC as part of the management software sends a group leader query message with its network address and its topology position to a parameterized set of network elements. It is sent as a multicast or broadcast message. For as long as the MRC receives no reply to its group leader query message, it continues to wait for parameterized lengths of time and continues to re-send the group leader query message.

A MRC 5 may or may not get a reply to a group leader query message. If no neighbours that are running a LRC 6 or MRC for the topology in question at the topology level in question, then the MRC will receive no reply. If a LRC receives the group leader query event and decides not to admit the MRC in question into its group, the LRC will not reply to the MRC. If a MRC sends a parameterized number of group leader query events without receiving a reply, it assumes that it is a group member at the top of a topology and it sets the “top” flag in the TE topology data entry for that level. The MRC issues a top of topology event to any external entities that have subscribed for that event.

Group Leader Promotion

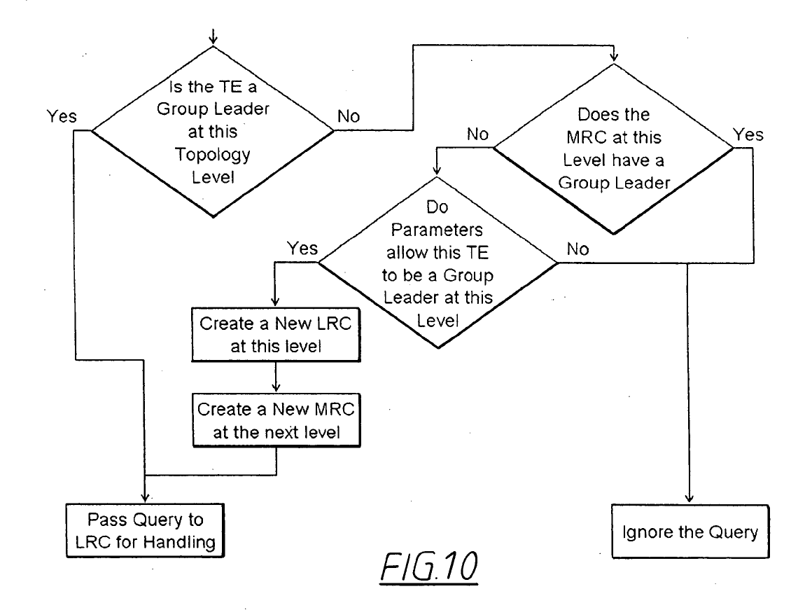

One sequence relates to the promotion of a group leader, see FIG. 10 which shows the handling of a group leader query message by a TE 4. If the TE is already a group leader at a level, the TE passes the message to the LRC 6 at that level for handling. If the TE is a group member at a level which has a group leader, the TE drops the message because it assumes the TE with the LRC for this group will instead handle the message. If the TE is a group member at that level which has no group leader, it checks the topology parameters and, if the parameter check permits, promotes itself to group leader at the level in question. It does this by the consecutive steps of: (1) shutting down the MRC 5 that is running at the level in question, (2) starting a LRC for the level in question and (3) starting a MRC for next level up from the level in question and (4) changes the topology data table in the TE to indicate that the TE is group leader at the level in question and group member at the next level up from the level in question. The group leader query message is passed to the new LRC for handling.

LRC Start

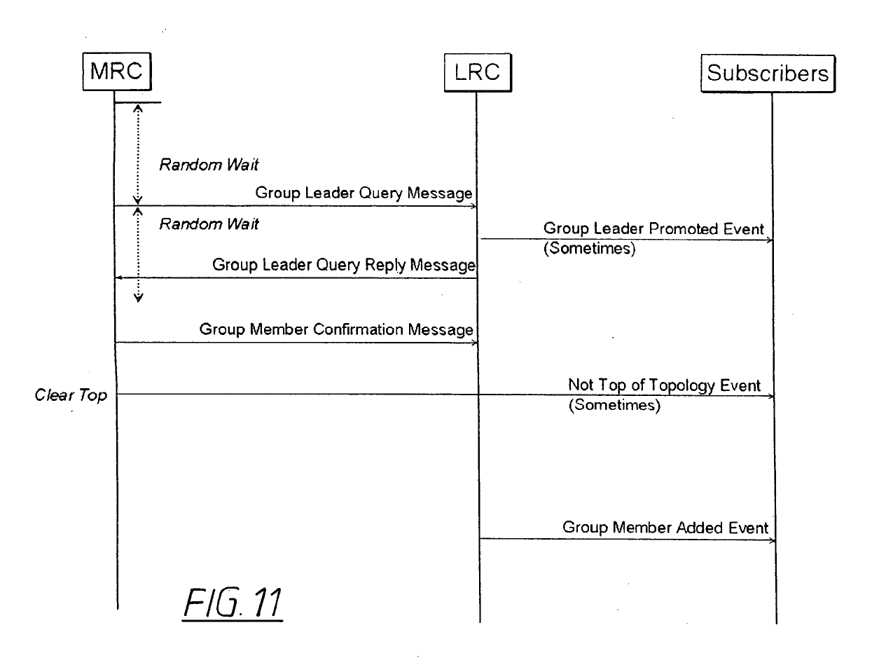

Still another sequence relates to LRC 6 start. When a LRC starts it initializes a list to hold the addresses of its group members. Initially, this list includes the address of the TE itself. The LRC issues a group leader promoted event to any external entities that have subscribed for that event, see FIG. 11.

Group Member Addition

FIG. 11 also shows the sequence of messages that are used to add member to a topology group. As explained above, a MRC 5 finds a group leader by sending a group leader query message to a parameterized set of neighbours. The message is received and handled by any LRC 6 that is running or is started at the topology level in question in TEs for that topology in the set of neighbours. Each LRC checks its set of parameters to see if it is allowed to accept the MRC that sent the message as a member of its group. If the MRC is accepted as a group member, the LRC reserves a place for the MRC as a member of its group and sends a group leader query reply message to the MRC. If the MRC is not accepted as a member, the LRC drops the group leader query message and does not reply to the MRC.

When a MRC 5 receives a group leader query reply message, it checks some parameters to see if it is allowed to become a member of the group of that LRC 6. It sends a group member confirmation message to the LRC, indicating that it agrees to become a member of the group. A MRC may receive more than one reply to a group leader query message. The MRC always responds to and joins the group of the first LRC that replies and is acceptable, ignoring all other replies. The group member supervision on those LRCs removes the MRC reservation after a certain timeout has expired.

When the LRC 6 receives a group member confirmation message, it confirms the MRC 5 as a member of its group. The LRC issues a group member added event to any external entities that have subscribed for that event. A MRC assumes that it is at the top of the topology when it has not received a group leader query reply event for a certain period of time. In that case, a MRC will have issued a top of topology event to external entities that have subscribed for that event. When a MRC does receive group leader query reply event, it is no longer at the top of the topology. It clears its top of topology flag and issues a not top of topology event to external entities if it had previously issued a top of topology event.

Group Member Supervision by Group Leaders

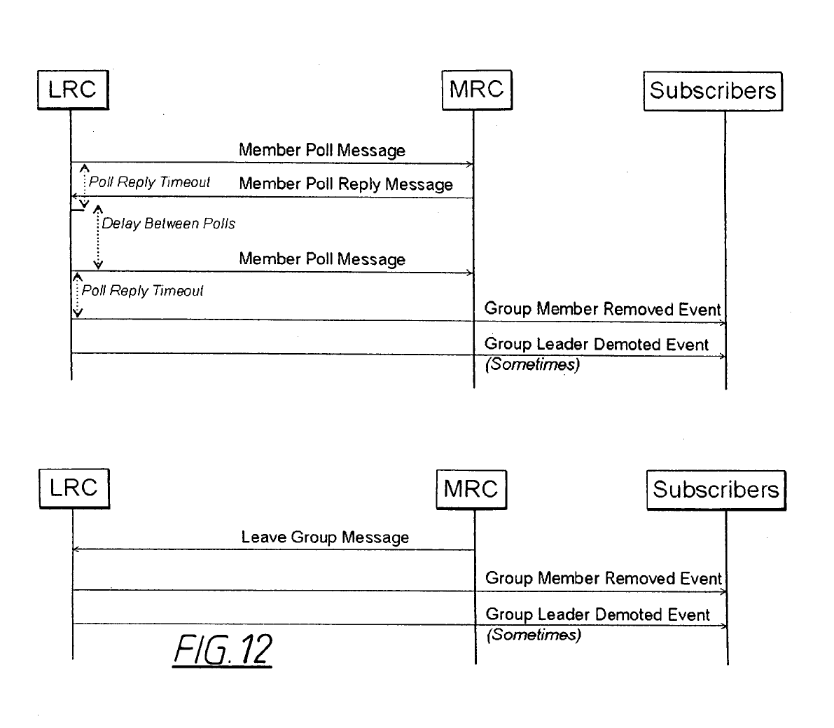

One sequence relates to group member control by group leaders, see FIG. 12, showing the polling interaction between a LRC 6 and a MRC 5. When a LRC starts, it commences supervising the group members included in its member table. The LRC keeps track of a set of counters for each of its MRC members. Each counter is initialized to a value set by a parameter. The supervision scan runs periodically, the scan interval being controlled by a parameter. Each time the supervision scan runs, the LRC decrements each counter for each MRC member. When the value of a counter reaches zero, the LRC carries out some action related to that counter. A LRC uses group member supervision to monitor the registration procedure for group members and to carry out polling of group members to ensure that they still exist as members of the group. The LRC supervises the following three situations for group members.
1. When membership of a group is reserved as a result of a group leader query message, a scan counter is set for that member. If membership is not confirmed by the MRC with a group member confirmation message before the scan counter for the member times out, the LRC removes the MRC from the group.
2. When a MRC is confirmed as a member of a group with a group member confirmation message, a polling counter is set for that member. When that counter reaches zero, the LRC polls the MRC with a member poll message.
3. When a MRC is polled with a member poll message, a polling timeout counter is set for that member. If the member poll message is not confirmed by the MRC with a member poll reply message before the polling timeout counter for the member times out, the LRC removes the MRC from the group.

When a LRC 6 has completed a scan of all its members, it checks the member list for its group. If the LRC itself is the only member of the group, then the TE should no longer be a group leader at that level. The TE demotes the LRC at the level in question to being a MRC 5.

Group Member Removal

There is a sequence that relates to group member removal, see also FIG. 12, which shows a message sequence for group member removal. A group member is removed from a group in a number of situations such as: (1) when a group member is shut down or restarts, (2) when a LRC 6 cannot communicate with a MRC 5 due to an underlying communication failure, (3) when a LRC poll towards a MRC fails or (4) when a LRC itself is shut down. In all of the above situations, the LRC removes the MRC from its list of members. If the group member was a confirmed member, the LRC issues a group member removed event to any external entities that have subscribed for that event.

Group Leader Demotion

Another sequence relates to group leader demotion, also FIG. 12, showing that the LRC 6 issues a group leader demoted event to external entities. When the group leader supervision algorithm determines that a group leader is the only member of a group at a particular level for this TE 4, the TE must amend its topology table entries and adjust the LRCs and MRCs 5 that are handling the topology levels in the TE. It does this by:
1. Shutting down the LRC that is running at the level in question.
2. Starting a MRC for the level in question
3. Changing the topology data table in the TE to indicate the TE is a group member at the level in question

As part of its shutdown sequence, The LRC issues the group leader demoted event to any external entities that have subscribed for that event as shown in the figure.

Group Member Lost of Group Leader

A group member can lose its group leader in a number of ways. For instance when a group leader is shut down or restarted, it sends a group leader shutdown message to all its group members. When a MRC 5 receives this message, it knows that it has lost its group leader. A second alternative is when a MRC has a group leader. It runs a supervision scan periodically. The supervision scan clears a poll flag and waits for a parameterized interval for a poll from the group leader. The group leader polls the MRC periodically with a member poll message. If the member poll message is received from the group leader that the MRC has recorded as the leader of its group, the MRC replies immediately with a member poll reply message. The MRC sets the poll flag. When the MRC supervision scan completes its wait; the MRC checks if the poll flag has been set. If the flag has not been set, the MRC assumes that the group leader has lost contact with the MRC. A third alternative is when a MRC cannot communicate with its group leader due to an underlying communication failure. In such a situation, it knows that it has lost its group leader. In all these three cases, the MRC restarts itself. The MRC clears its group leader and begins searching for a new group leader.

Topology Entity Shutdown and Restart

A topology shut down and restart sequence has the following steps. When a topology entity is shut down, it loops over the entries for each topology level in its topology data table starting at the top topology level and orders a shutdown on each MRC 5 and LRC 6 for those levels in order. A TE 4 restart is implemented by carrying out a TE shutdown followed immediately by a TE start.

Group Leader Shutdown

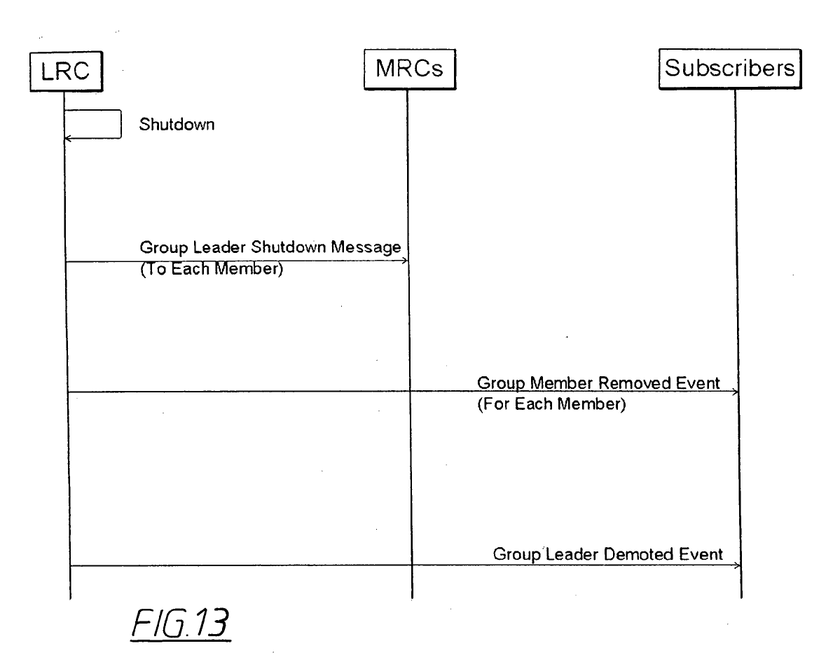

One sequence relates to the group leader shutdown, see FIG. 13. When a LRC 6 is shut down, it loops over its members. It sends a group leader shutdown message to each of its group members. It then issues a group member removed event for every group member in its group to any external entities that have subscribed for that event. Finally, it issues a group leader demoted event to any external entities that have subscribed for that event.

Group Member Shutdown

One sequence relates to group member shutdown, see FIG. 12. When a MRC 5 shuts down it checks if it has a group leader. If it has, it sends a leave group message to its group leader as shown in FIG. 12. If the MRC had assumed it was the group member at the top of a topology and had set the “top” flag, that flag is cleared. The MRC issues a not top of topology event to any external entities that have subscribed for that event.

Automatic Topology Adjustment as Network Conditions Change

The topology adjusts automatically as network elements and more specifically TEs 4 appear and disappear. See above text which describes these sequences for forming and reforming topologies, with reference to FIG. 9-13. The appearance of a TE causes that TE to be added to a group and may cause a new group to be formed or even a new topology level to be created. The disappearance of a TE causes that TEs membership and leadership of groups to be removed. This may cause topology levels and groups to disappear. A topology can also automatically adjust if the parameters used to control the topology structure are amended.

Exchange of Management Information between Topologies

Topology Entities and their LRCs 6 and MRCs 5 in a topology can find each others' addresses and can exchange information. An entity can use a topology to pass information to a single node in the topology, to all the nodes in a sub-tree of a topology, or to all the nodes in a topology. If more than one topology is running in a network, the topology entities for each topology can exchange information.

External Registration of Topologies

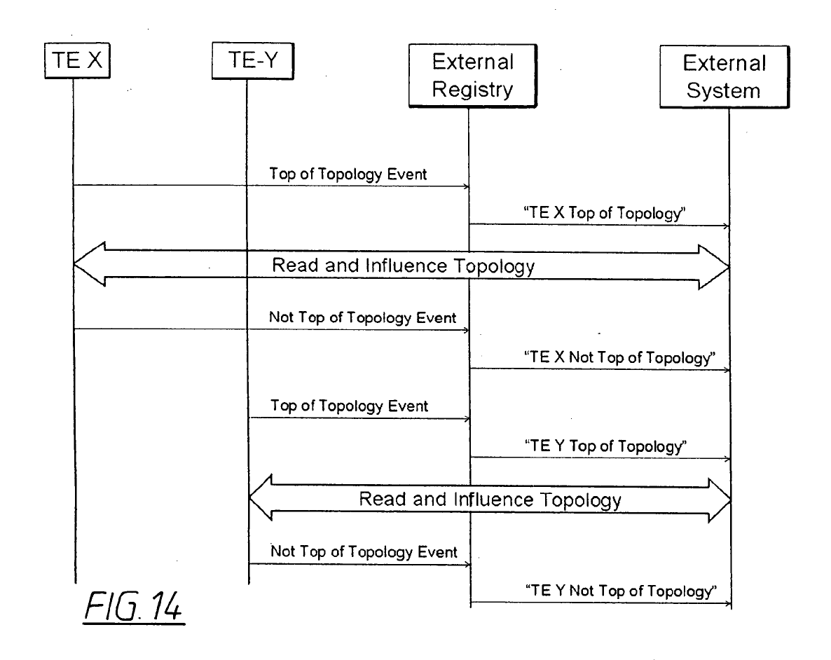

FIG. 14 shows a message sequence for external registration of topologies. When a MRC 5 assumes that it is at the top of a topology, it sends a top of topology message to subscribers. The MRC can also send that event to a parameterized address of a well known registry such as a UDDI repository. An external system can register with the registry to get the address of the network element and more specifically the TE 4 at the top of the topology. The external system can then open a direct communication session with the TE at the top of the topology. If the topology changes such that a TE that was at the top of the topology is no longer at the top of the topology, the TE sends a not top of topology message to the well known registry. External systems are then informed that the address they are using to address the topology is no longer valid. If another TE becomes top of the topology, it in turn registers with the registry and external systems will be informed of the address of the new TE that is at the top of the topology.

Navigation of Topologies and Reading of Topology Data by External Systems

An external system can communicate with and navigate from any TE in the topology once it has the address of the TE. An external system can find the address of the top TE 4 in a topology using the mechanism described as just described. When a system external to a topology accesses a TE for a topology on a network element, that system can read and navigate the topology using a number of operations. The operations that are available from a TE to which an external system is connected include those described on the following list.
1. Read the ID and address information of the connected TE.
2. Read the IDs and address information of all TEs that are adjacent to the connected TE.
3. Read the top level of grouping defined on the connected TE.
4. Check if the connected TE is the top TE in the hierarchy.
5. Read the ID and address of the group leader of groups which the connected TE is a member of.
6. Read the IDs and address information of group members of groups which the connected TE is a member of.
7. Read the structure of the topology for the connected TE, for all TEs below the connected TE in the topology, or for a set of TEs below the connected TE in the topology identified by a given scope and filter parameter.
8. Read the application data associated with a topology for the connected TE, for all TEs below the connected TE in the topology, or for a set of TEs below the connected TE in the topology identified by a given scope and filter parameter.

Using the operations on the list above, an external system can traverse the entire topology once it has the address of any TE in the topology.

Parameterization of Network Management Topologies

The structure and maintenance of a topology is controlled by a number of parameters. The following non-exhaustive list describes parameters that can be used by topologies.
1. The minimum length of time a LRC 6 or MRC 5 waits before it starts, and a random interval after that in which a LRC or MRC will start. Therefore, a MRC or LRC will always wait for a certain interval before starting and then will wait for a random time from a given time interval before starting.
2. The number of group leader queries a MRC sends before assuming it is at the top of the topology.
3. Application parameters indicating the conditions that must be fulfilled before a TE can become a group leader at a topology level.
4. Topological parameters such as group size that a group leader uses to assess if a group member can join its group.
5. Application parameters that a group leader uses to assess if a group member can join its group.
6. Topological parameters such as hop count that a group member uses to assess if it should join a group that a group leader has invited it to join.
7. Application parameters that a group member uses to assess if it should join a group that a group leader has invited it to join.
8. The length of time between scans of group members by group leaders.
9. The amount of time that a group leader holds a group member reservation before cancelling the reservation.
10. The amount of time between member polls by group leaders.
11. The amount of time that a group leader waits for a reply to a poll of a group member before removing them member from its group.
12. The amount of time that a group member waits for a poll from a group leader before deciding that its group leader is unavailable.
13. The address of well known registries where the address of TEs at the top of a topology can be registered.

Modification, Control, Reset and Reforming of Topologies by External Systems

Operations are available from a TE 4 to which an external system is connected to allow that external system to read and change parameter values. Operations that are available from a TE to allow that external system to read and change parameter values can be used by a Policy Based Management System (PBMS) to control the topology parameters. Operations are also available from a TE to which an external system is connected to allow that external system to reset and reform the topology for the connected TE, for all TEs below the connected TE in the topology, or for a set of TEs below the connected TE in the topology identified by a given scope and filter parameter.

Monitoring of Topologies by Other Applications or External Systems

A TE 4 supports the concept of notification subscription for events. Other applications on the network element on which the TE is running or applications running on external systems can subscribe for these notifications. The events allow those applications to keep track of the topology as it changes. The following list details events to which a subscription can be made.
1. Top of Topology Event. Issued when a MRC 5 (and therefore a TE) realize that it is at the top of the topology. This event is issued when a MRC has tried a parameterized number of times to find another MRC at its level and has failed. It then assumes that it is at the top of the topology. Note that when this event is issued, the MRC continues searching for another MRC at its level because another MRC might well appear at any time.
2. Not Top of Topology Event. Issued when a MRC (and therefore a TE) realize that it is no longer at the top of the topology.
3. Group Leader Promoted Event. Issued when a LRC 6 is created.
4. Group Member Added Event. Issued when a LRC adds a MRC to its group.
5. Group Member Removed Event. Issued when a LRC removes a MRC from its group.
6. Group Leader Demoted Event. Issued when a LRC is removed.

Operations are available from a TE 4 to which an external system is connected to allow that external system to handle its subscriptions to events. The operations that are available are listed below.
1. Subscribe to a set of events on the connected TE, for all TEs below the connected TE in the topology, or for a set of TEs below the connected TE in the topology identified by a given scope and filter parameter.
2. Unsubscribe from a set of events on the connected TE, from all TEs below the connected TE in the topology, or from a set of TEs below the connected TE in the topology identified by a given scope and filter parameter.
3. Remove all event subscriptions from the connected TE, from all TEs below the connected TE in the topology, or from a set of TEs below the connected TE in the topology identified by a given scope and filter parameter.

1. A network management system operating in a computer or telecommunication network, the network comprising at least one network element that is able to communicate in the network through links, wherein network management software is contained and run on the network element, the network management software comprising:
controlling means for each management function or functions that the network element is part of, the controlling means being able to form, reform and/or terminate the topology for the management function; and
register means for each management function or functions that the network element is part of, the register means being able to register and share information about the topology for the management function.

2. Network management system according to claim 1, wherein at least one network element is formed into a topological group for a management function.

3. Network management system according to claim 2, wherein one network element in the group has the role of group leader for this group, wherein the group leader coordinates and displays the topology of its group.

4. Network management system according to claim 2, wherein the network element can be part of more than one topological group, depending on the management function.

5. Network management system according to claim 2, wherein there is at least one topological group for each management function.

6. Network management system according to claim 2, wherein the management function group constitutes a part of a hierarchic topology of layered groups and forming the entire network for the management function.

7. Network management system according to claim 6, wherein a network element in one topology level is group leader for a group of network elements on the level next below, wherein the group leader of the highest topological group represents the entire network.

8. Network management system according to claim 2, wherein the topology groups are formed, reformed and terminated based on parameters.

9. Network management system according to claim 8 wherein the parameters are set statically before system start-up, dynamically while the system is running, or deduced at run time by reading state information from the network and calculating their value.

10. Network management system according to claim 8, wherein the reforming relates to the structure of the topology or the hierarchy, the size of the group or promotion/demotion of group leader.

11. Network management system according to claim 1, wherein the register means of a specific network element appears at more than one position in a topology for a specific management function.

12. Network management system according to claim 1, wherein the register means uses a table to hold topological data with an entry for each position in the management function topology that the register means appears in.

13. Method for managing a network management system operating in a computer or telecommunication network, the network comprising at least one network element that is able to communicate in the network through links, wherein network management software is contained and run on the network element, wherein the following steps are performed:
forming, reforming and/or terminating the topology for each management function or functions that the network element is part of, said step being performed by controlling means included in the network management software; and
registering and sharing information about the topology for each management function or functions that the network element is part of, said steps being performed by register means included in the network management software.

14. Method for managing a network management system according to claim 13, wherein a starting of a network element comprises the steps of:
a member role controller, which is part of the controlling means, sending a group leader query message for each management function to a parameterized set of network elements; and
waiting for a parameterized length of time and continuing to re-send the message as long as no reply is received, the message containing the elements address and its topology position

15. Method for managing a network management system according to claim 13, wherein a promotion of a group leader for a topology group for a management function comprises the steps of:
when the register means is the group leader the group leader passes a group leader query message to a leader role controller being part of the controlling means; and
if there is no group leader for the group, the register means for that group controls the permission to promote itself to group leader for this group.

16. Method for managing a network management system according to claim 13, wherein when a leader role controller, which is part of the controlling means, starts the leader role controller initializes a list to hold the addresses of the members of a topology group for a management function to which it relates, initially including the address of the register means for this controller.

17. Method for managing a network management system according to claim 13, wherein a topology group member addition to a topology group for a management function comprises the steps of:
a member role controller of a register means, which is part of the controlling means, sending a group leader query message which is received by a leader role controller;
a leader role controller for that group, which is part of the controlling means, sending a group leader reply message if the register means is permitted as member of this group;
the member role controller sending a group member confirmation message if the register means agrees to become member of the group; and
the leader role controller issuing a group member added event to confirm that the register means is permitted as member of this group.

18. Method for managing a network management system according to claim 13, wherein a topology group leader supervision of group members of a topology group for a management function comprises the steps of:
a leader role controller, which is part of the controlling means, for the group keeping track of a set of counters for each of its group member;
a scan running periodically, the scan interval being controlled by a parameter;
each time the scan runs the leader role controller decrementing each counter for a member role controller group member; and
when a counter reaches 0 the controller carrying out some actions related to that counter.

19. Method for managing a network management system according to claim 13, wherein a topology group member removal from a topology group for a management function comprises the steps of:
a leader role controller removing a member role controller for the topology group member from its list of members, which controllers are part of the controlling means; and
if the group member was a confirmed member issuing a group member removed event.

20. Method for managing a network management system according to claim 13, wherein a topology group leader demotion in a topology group for a management function comprises the steps of:
a leader role control determining that a group leader is the only member of the group at a particular group level for this register means;
the register means for this member amending its table entries;
the register means adjusting member role controllers and the leader role controllers that handles the topology groups in the register means;
the leader role control issuing a group leader demotion event to external entities; and
the controllers being part of the controlling means.

21. Method for managing a network management system according to claim 13, wherein a register means shutdown from a topology group for a management function comprises the steps of:
looping over the entries for each topology level in its topology data table starting at the top topology level; and
ordering a shutdown in each member role controller and leader role controller for those levels, the controllers being part of the controlling means.

22. Method for managing a network management system according to claim 13, wherein a group leader shutdown in a topology group for a management function comprises the steps of:
looping over the topology group's members;
sending a group leader shutdown message to each of the group members;
issuing a group member removed event; and
issuing a group leader demotion event.

23. Method for managing a network management system according to claim 13, wherein a group member shutdown in a topology group for a management function comprises the steps of:
checking if the group member has a group leader and if so then sending a leave group message to the leader; and
issuing a group member removed event.

24. Method for managing a network management system according to claim 13, wherein an external registration of topologies for management functions comprises the steps of:
sending a top of topology message to an external entity;
the external entity register with the registry to get the address of the network element; and
the external entity opening a direct communication session with the register means at the top level of the topology.

25. Method of managing a network management system according to claim 13, wherein the register means for a particular management function topology communicates and co-operates with other register means to form and reform the entire topology for the network.

26. Method for managing a network management system according to claim 13, wherein the register means track the topological data for the network element itself and the topological connections the network element has with register means in other network elements.

27. Method for managing a network management system according to claim 13, wherein a topological event such as reformation of management function topology is issued by the network management software and sent to an external management system.

28. A network element that is able to communicate in a computer or telecommunication network through links, wherein network management software is contained and run on the network element, wherein the network management software comprises:
controlling means for each management function or functions that the network element is part of, the controlling means being able to form, reform and/or terminate the topology for the management function; and
register means for each management function or functions that the network element is part of, the register means being able to register and share information about the topology for the management function.

29. Network element according to claim 28, wherein each register means is identical and parameters influence the way in which each register means registers and shares information about the topology for the management function and the way in which each register means interacts with other register means.

30. Network element according to claim 28, wherein the controlling means comprises role controllers, the controllers being contained and run in the network element for each management function or functions that the network element is part of.

31. Network element according to claim 30, wherein the role controllers are able to form, reform and/or terminate the topology of the management function by controlling the permission to perform certain operations that are assigned to certain roles in a management function topology.

32. Network element according to claim 30, wherein more than one role controller is run in each storage means.

33. Network element according to claim 28, comprising a management module that is run on the network element, the module comprising the network management software.

34. Network element according to claim 28, wherein the network element is in a telecom or data node.

35. Network element according to claim 28, wherein the element communicates within the network with software protocols.

36. Network element according to claim 28, wherein the register means uses a table to hold topological data with an entry for each position in the management function topology that the register means appears in.

37. Network element according to claim 28, wherein the register means of a specific network element appears at more than one position in a topology for a specific management function.
